(19) United States
(12) Patent Application Publication
(10) Pub. No.: US 2018/0142176 A1
(43) Pub. Date: May 24, 2018

(54) SYSTEM FOR PURIFYING BIOGAS

(71) Applicants: Tze-Ming KAO, Taipei (TW); Tzu-Yu PENG, Hsinchu City (TW)

(72) Inventors: Tze-Ming KAO, Taipei (TW); Tzu-Yu PENG, Hsinchu City (TW)

(21) Appl. No.: 15/355,987

(22) Filed: Nov. 18, 2016

(51) Int. Cl. C10L 3/10; B01D 19/00; B01D 53/14

(52) U.S. Cl. CPC C10L 3/104; B01D 19/0031; B01D 53/1425; B01D 53/1475; C10L 2290/542; B01D 53/1493; B01D 2252/103; C10L 2290/547; B01D 19/0073

(57) ABSTRACT

Provided is a system for purifying biogas. The system for purifying biogas utilizes a separating unit for methane and carbon dioxide that connects to a separating unit for biogas and a separating unit for carbon dioxide to separate methane and carbon dioxide from the biogas. The separating unit for methane and carbon dioxide may separate the methane and the carbon dioxide. The separating unit for carbon dioxide may separate water and the carbon dioxide. The system for purifying biogas provides high concentration methane for use as fuel for motor vehicles and recycle the water to separate biogas repeatedly.

### BACKGROUND OF THE INVENTION

### 1. Field of the Invention

The present invention relates to a field of biogas purification, and more particularly to a system for purifying biogas.

### 2. Description of the Related Art

With the progress of technology and improvement of living standard, almost every household has at least a motorcycle or at least a car for transportation. For energy supply to such a vast amount of motorcycles and cars, the petroleum industry has accelerated petroleum extraction in recent years. According to studies, formation of petroleum takes thousands, even tens of thousand of years. On the basis of the current pace on extraction and consumption, the resources of petroleum on earth will soon come to depletion. An important issue is to find and develop an alternative energy instead of petroleum wherein biogas is one of the highly potential alternatives of energy.

The biogas is formed in wetlands around the riversides. Rotten plants form organic materials in wetlands, allowing anaerobic digestion and fermentation and eventually forming biogas. The principal compositions of the biogas are methane and carbon dioxide.

According to current studies, methane at high concentration can be used as the fuel for motor vehicles. A major technical issue for scientists to adopt the biogas as an alternative energy is how to remove the carbon dioxide from the biogas.

In view of the abovementioned problems, Taiwan patent No. 267365 discloses a regenerative purifying equipment for biogas by water. The regenerative purifying equipment utilizes water to separate inputted biogas comprising methane and carbon dioxide. The regenerative purifying equipment facilitates dissolution and adsorption of the carbon dioxide in water and then output only the methane to accomplish purification of the biogas. But carbon dioxide has very low solubility and adsorption in water at room temperature. In theory, the users need to use high pressure to the surface of water if users want to enhance the solubility of the carbon dioxide in water. When the high pressure is released, carbon dioxide will separate from water again. However, processes of the enhance pressure and release pressure are hard to control. The processes of the enhance pressure and release pressure need to consume a lot of energy. The processes of the enhance pressure and release pressure also need a large contacting area between carbon dioxide and water. By the above theory, the methane outputted from the regenerative purifying equipment still contains a lot of carbon dioxide. The methane purification of the biogas is not efficient. The methane outputted from the regenerative purifying equipment cannot be directly utilized as a fuel for motor vehicles.

### SUMMARY OF THE INVENTION

An objective of the present invention is to provide a system to resolve the problems about separating carbon dioxide from water dissolving and adsorbing carbon dioxide. The system of the present invention can promote carbon dioxide dissolving in water at normal pressure. The system also can raise the temperature to increase removal amount of carbon dioxide from water dissolving and adsorbing carbon dioxide. The system also adds carbon dioxide adsorbents into the water to completely separate carbon dioxide from water dissolving and adsorbing carbon dioxide. After completely separating water and carbon dioxide, water can be recycle for repeated use to separate methane and carbon dioxide in biogas.

To achieve the foregoing objective, the present invention provides a system for purifying biogas comprising: a separating unit for biogas, a separating unit for methane and carbon dioxide, and a separating unit for carbon dioxide. The separating unit for methane and carbon dioxide connects to the separating unit for biogas and the separating unit for carbon dioxide. The separating unit for biogas comprises a biogas inlet and a methane outlet. The biogas comprises methane and carbon dioxide. The separating unit for methane and carbon dioxide connects to the biogas inlet and the methane outlet. The separating unit for methane and carbon dioxide is mounted between the biogas inlet and the methane outlet. The separating unit for carbon dioxide comprises a heater, a carbon dioxide filter, a water tank, a dosing device, and a vacuum pump. The heater connects to the separating unit for methane and carbon dioxide. The carbon dioxide filter connects to the heater. The water tank connects to the carbon dioxide filter. The separating unit for biogas is mounted between the heater and the water tank. The dosing device connects to the water tank independently. The vacuum pump connects to the water tank independently.

The advantage of the present invention is utilizing the separating unit for methane and carbon dioxide to separate methane and carbon dioxide from the biogas. In addition, as the separating unit for methane and carbon dioxide simultaneously connects to the separating unit for biogas and the separating unit for carbon dioxide, carbon dioxide is removed from the biogas to obtain purified methane at high concentration. Furthermore, the present invention also utilizes the separating unit for carbon dioxide to separate water and carbon dioxide that dissolving and adsorbing in water. The separated water may be recycled to the separating unit for methane and carbon dioxide to remove carbon dioxide from the biogas repeatedly. The separated water is used to purify the biogas continuously. The system for purifying biogas of the present invention can continuously provide purified methane at high concentration. The present invention further utilizes the heater to control the temperature of the water dissolving and adsorbing carbon dioxide. The capability of water to release carbon dioxide may be regulated by changing the temperature of the water.

Particularly, carbon dioxide adsorbents are stored in the dosing device.

More particularly, the carbon dioxide adsorbent is methyldiethanolamine (MDEA), triethylenetetramine (TETA), aminoethylethanolamine (AEEA), or a combination thereof or active carbon or zeolite.

Particularly, a carbon dioxide membrane is mounted in the carbon dioxide filter. The carbon dioxide membrane has multiple micropores. Only carbon dioxide molecules can pass through the micropores of the carbon dioxide membrane. Water molecules cannot pass through the micropores of the carbon dioxide membrane. The carbon dioxide membrane can separate water and carbon dioxide from a solution containing dissolved and adsorbed carbon dioxide. Then pure water is obtained. Furthermore, the carbon dioxide membrane also can increase contacting area between carbon dioxide and water. The volume of the system in the present invention also can be decrease.

More particularly, one part of the carbon dioxide membrane is in a vacuum condition. The other part of the carbon dioxide membrane is filled with the solution containing dissolved and adsorbed carbon dioxide. In particular, the space in the carbon dioxide filter is divided to two parts by the carbon dioxide membrane. One part of the space is a gas phase space in a nearly vacuum condition, and the other part of the space is a liquid phase space with water and carbon dioxide. When water and carbon dioxide are transported into the liquid phase space, carbon dioxide will transfer to the gas phase space through the micropores of the carbon dioxide membrane because the atmospheric pressure in the gas phase space is lower than the atmospheric pressure in the liquid phase space. Separation of water and carbon dioxide is achieved.

Particularly, a water-level controller is mounted on the top of the water tank. A water drainage device is mounted on a sidewall of the water tank. The advantage of the present invention is utilizing the water-level controller to detect the level of water in the water tank and control the water drainage device to work. The water drainage device is actuated when the water is above a full water level line of the water tank as detected by the water-level controller. The water drainage device may effectively prevent the water spilling over the water tank.

Particularly, the heater regulates the temperature to remain in a range from 30° C. to 70° C. The water dissolving and adsorbing carbon dioxide can release carbon dioxide at high temperature. The advantage of the present invention is utilizing the heater to heat the water dissolving and adsorbing carbon dioxide, thereby enhancing the efficiency of the separation between water and carbon dioxide.

Particularly, the separating unit for carbon dioxide further comprises a carbon dioxide discharger and a water supply. The carbon dioxide discharger and the water supply connect to the carbon dioxide filter. A degas pump is mounted between the carbon dioxide discharger and the carbon dioxide filter. The degas pump is to transport the separated carbon dioxide to the carbon dioxide discharger from the gas phase space of the carbon dioxide filter. The separated carbon dioxide can be discharged from the carbon dioxide discharger. The separated carbon dioxide may not remain between the carbon dioxide filter and the carbon dioxide discharger. The separated carbon dioxide may be used for other applications. The water supply can provide adequate water to dissolve and adsorb carbon dioxide to the separating unit for methane and carbon dioxide. Water from the water supply can be stored in the water tank with the separated water from the carbon dioxide filter.

Particularly, the separating unit for carbon dioxide further comprises a cooler. The cooler comprises a hot water pipe and a cold water pipe. The cooler connects to the water tank by the hot water pipe and the cold water pipe. The advantage of the present invention is utilizing the cooler to control the temperature of the water stored in the water tank. The solubility and adsorption of carbon dioxide in the water can be adjusted by regulating temperatures of the water by the cooler.

Particularly, the system for purifying biogas further comprises two degas pumps and a hydraulic pump. One of the degas pumps is mounted between the biogas inlet and the separating unit for methane and carbon dioxide, and another one of the degas pumps is mounted between the separating unit for methane and carbon dioxide and the methane outlet. The hydraulic pump is mounted between the water tank and the separating unit for methane and carbon dioxide. The advantage of the present invention is utilizing the degas pumps and the hydraulic pump to help gas and liquid transfer and move within the system. The degas pumps and the hydraulic pump can increase operation fluency of the system and enhance the efficiency for purifying biogas.

### BRIEF DESCRIPTION OF THE DRAWINGS

FIG. 1 is a diagram of the system for purifying biogas in accordance with the present invention;

FIG. 2 is an operational diagram of the system for purifying biogas with the separating unit for methane and carbon dioxide in accordance with the present invention; and

FIG. 3 is a structural and operational diagram of the system for purifying biogas with the carbon dioxide filter in accordance with the present invention.

### DETAILED DESCRIPTION OF THE INVENTION

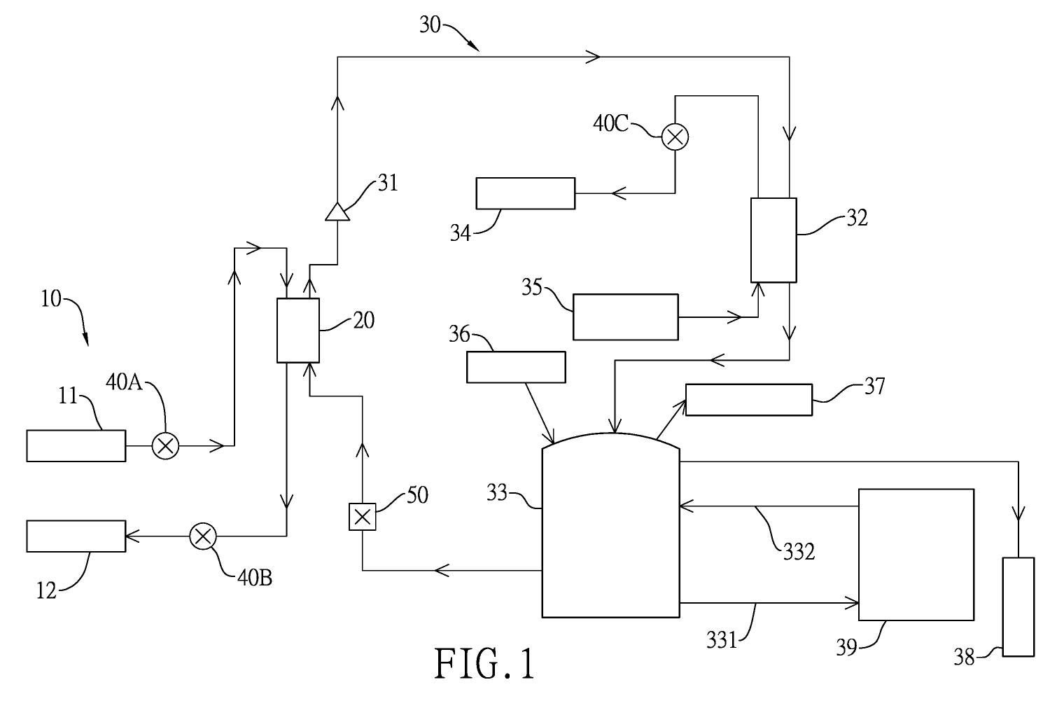

With reference to FIG. 1, the system for purifying biogas comprises a separating unit for biogas 10, a separating unit for methane and carbon dioxide 20, a separating unit for carbon dioxide 30, three degas pumps 40A, 40B, 40C, and a hydraulic pump 50.

The separating unit for biogas 10 has a biogas inlet 11 and a methane outlet 12. The biogas is a mixed gas that comprises methane and carbon dioxide. The separating unit for methane and carbon dioxide 20 connects to the biogas inlet 11 and the methane outlet 12. More particularly, the separating unit for methane and carbon dioxide 20 is mounted between the biogas inlet 11 and the methane outlet 12. The biogas comprising methane and carbon dioxide may flow into the separating unit for methane and carbon dioxide 20 from the biogas inlet 11. Pure methane may be obtained from the biogas by the separating unit for methane and carbon dioxide 20 and then flow into the methane outlet 12. Pure methane may be released from the methane outlet 12 for use as an alternative energy instead of petroleum.

Furthermore, a degas pump 40A is mounted between the biogas inlet 11 and the separating unit for methane and carbon dioxide 20. The degas pump 40A is to transport the biogas to the separating unit for methane and carbon dioxide 20 from the biogas inlet 11 for separating methane and carbon dioxide. Moreover, another degas pump 40B is mounted between the separating unit for methane and carbon dioxide 20 and the methane outlet 12. The degas pump 40B is to transport the separated methane to the methane outlet 12 from the separating unit for methane and carbon dioxide 20 for discharging the pure methane. The separated methane may not remain between the separating unit for methane and carbon dioxide 20 and the methane outlet 12. The degas pump 40B reduces waste of the separated methane.

The separating unit for carbon dioxide 30 has a heater 31, a carbon dioxide filter 32, and a water tank 33. The carbon dioxide filter 32 further connects to a carbon dioxide discharger 34 and a water supply 35. The water tank 33 further connects to a dosing device 36, a vacuum pump 37, a water drainage device 38, and a cooler 39.

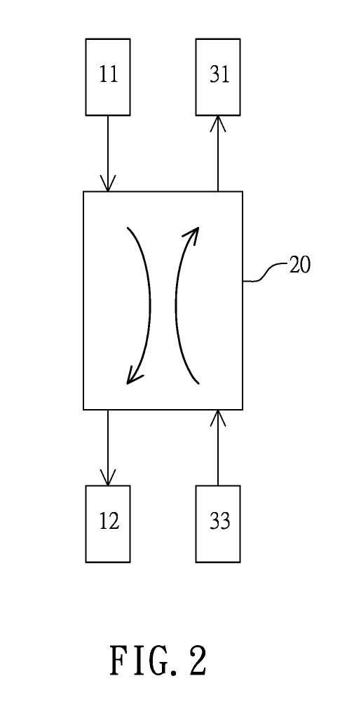

The heater 31 and the water tank 33 connect to the separating unit for methane and carbon dioxide 20. Particularly, the separating unit for methane and carbon dioxide 20 is mounted between the heater 31 and the water tank 33. The water may be transported from the water tank 33 into the heater 31 through the separating unit for methane and carbon dioxide 20. Then the water is heated by the heater 31. With reference to FIG. 2, carbon dioxide of the biogas may be dissolved in the water and adsorbed by the water molecules from the water tank 33 in the separating unit for methane and carbon dioxide 20. The carbon dioxide of the biogas may be removed by the water in the separating unit for methane and carbon dioxide 20, and the carbon dioxide may further be transported to the heater 31 from the separating unit for methane and carbon dioxide 20 to increase the temperature of the solution containing carbon dioxide. The heater 31 is to effectively separate carbon dioxide molecules and water molecules. The purity of the methane between the separating unit for methane and carbon dioxide 20 and the methane outlet 12 may be increased by the above dissolution and adsorption of carbon dioxide. Methane of higher level of purification may be discharged for use from the methane outlet 12.

The heater 31 may raise the temperature from the room temperature to about 30° C. to 70° C. of the solution dissolved with carbon dioxide. The heater 31 decreases the solubility and the adsorption between carbon dioxide molecules and water molecules. The heater 31 helps carbonic acid solution to decompose to water and carbon dioxide. The heater 31 also helps to separate adsorbed carbon dioxide molecules and water molecules. The heater 31 connects to the carbon dioxide filter 32. Then water and carbon dioxide are transported to the carbon dioxide filter 32 for separation as described below.

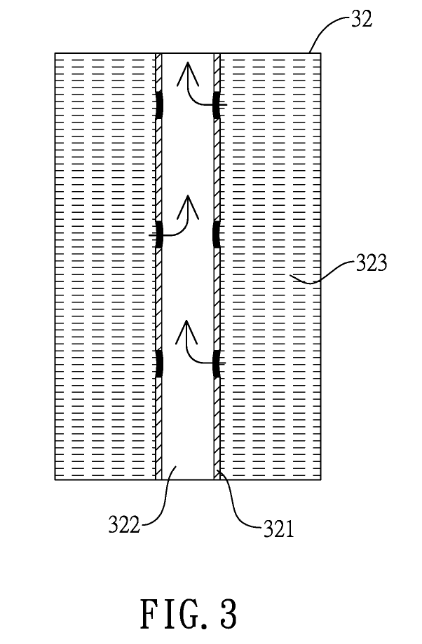

A carbon dioxide membrane 321 is mounted in the carbon dioxide filter 32. The carbon dioxide membrane 321 has multiple micropores. The pore size of each micropores is about 0.03 μm. Carbon dioxide molecules can pass through the micropores of the carbon dioxide membrane 321, but water molecules cannot pass through the micropores of the carbon dioxide membrane 321. With reference to FIG. 3, the space in the carbon dioxide filter 32 is divided to two parts. One part of the space is a gas phase space 322 in a nearly vacuum condition, and the other part of the space is a liquid phase space 323 with water and carbon dioxide. When water and carbon dioxide are transported into the liquid phase space 323 together, carbon dioxide will transfer to the gas phase space 322 through the micropores of the carbon dioxide membrane 321 because the atmospheric pressure in the gas phase space 322 is lower than the atmospheric pressure in the liquid phase space 323. The carbon dioxide filter 32 connects to the water tank 33. Water will flow into the water tank 33 because water cannot pass through the micropores of the carbon dioxide membrane 321. The carbon dioxide membrane 321 helps to separate water and carbon dioxide.

The carbon dioxide discharger 34 connects to the gas phase space 322. A degas pumps 40C is mounted between the carbon dioxide filter 32 and the carbon dioxide discharger 34. The degas pump 40C is used to transport the separated carbon dioxide to the carbon dioxide discharger 34 from the gas phase space 322 of the carbon dioxide filter 32. The separated carbon dioxide may be discharged from the carbon dioxide discharger 34. The separated carbon dioxide may not remain between the carbon dioxide filter 32 and the carbon dioxide discharger 34. The degas pump 40C prevents increasing the atmospheric pressure in the gas phase space 322. The degas pump 40C increases the efficiency of separating water and carbon dioxide in the carbon dioxide filter 32.

Furthermore, the water supply 35 connects to the liquid phase space 323 of the carbon dioxide filter 32. As evaporation of water is accelerated by the heater 31 in the system, the water supply 35 continuously supplies adequate water to dissolve and adsorb carbon dioxide. Water from the water supply 35 can be stored in the water tank 33 with the separated water from the carbon dioxide filter 32.

The separated water from the carbon dioxide filter 32 in the water tank 33 contains some remaining carbon dioxide. In order to remove the remaining carbon dioxide in the water tank 33, the dosing device 36 connects to the water tank 33 and provides carbon dioxide adsorbents to the water tank 33. The carbon dioxide adsorbents are stored in the dosing device 36. The carbon dioxide adsorbent is MDEA, TETA, AEEA, or a combination thereof. The dosing device 36 can dispense the carbon dioxide adsorbents into the water tank 33 to completely separate water and the remaining carbon dioxide. Then the vacuum pump 37 may work to remove the remaining carbon dioxide. Finally, only water is stored in the water tank 33.

In addition, a water-level controller (not shown in the figures) is mounted on the top of the water tank 33. Furthermore, the water drainage device 38 is mounted on a sidewall of the water tank 33. The water-level controller may detect the level of water in the water tank 33. The water drainage device 38 may work when the water is above the full water level line of the water tank 33. The water drainage device 38 prevents the water spilling over the water tank 33 unexpectedly affecting the working of the system for purifying biogas.

Before providing water to the separating unit for methane and carbon dioxide 20 from the water tank 33, the cooler 39 connects to the water tank 33 through a hot water pipe 331 and a cold water pipe 332. Water in the water tank 33 may be transported to the cooler 39 through the hot water pipe 331 first, the water is cooled by the cooler 39 and then the cool water flows back to the water tank 33 for storage. According to the above cooling step, cool water may be provided to the separating unit for methane and carbon dioxide 20 from the water tank 33. The temperature of the cool water is about 22° C. to 26° C. Perfectly, the temperature of the cool water is 4° C. It is effective for promoting carbon dioxide dissolution and adsorption in the water. The water's capability of removing the carbon dioxide in the separating unit for methane and carbon dioxide 20 may be increased by cooling. The concentration of the methane in the methane outlet 12 may be increased by the cool water. The system for purifying biogas achieves purifying the biogas to methane.

In order to facilitate efficacy in transporting water to the separating unit for methane and carbon dioxide 20 from the water tank 33, the hydraulic pump 50 is mounted between the water tank 33 and the separating unit for methane and carbon dioxide 20. The hydraulic pump 50 may help to withdraw the cool water from the water tank 33 to the separating unit for methane and carbon dioxide 20 to separate methane and carbon dioxide.

In summary, the system for purifying biogas utilizes the heater 31 and the cooler 39 to control the temperatures of the water alternately to regulate the solubility of the water with carbon dioxide. At low temperature, carbon dioxide may have higher solubility and adsorption in cool water. At high temperature, carbon dioxide may have lower solubility and adsorption in hot water. The present invention increases the separation efficiency between methane and carbon dioxide from the biogas. The system for purifying biogas can provide pure methane for use as an alternative energy for environmental protection.

Furthermore, the system for purifying biogas utilizes the dosing device 36 and carbon dioxide adsorbents to separate the remaining carbon dioxide and water in the water tank 33. The vacuum pump 37 may work to remove the remaining carbon dioxide. The present invention ensures that water in the water tank 33 is pure water. Then the pure water can be provided to the separating unit for methane and carbon dioxide 20 to separate the methane and carbon dioxide in circulation. The system for purifying biogas also reduces waste of water resources.

What is claimed is:

1. A system for purifying biogas comprising:
a separating unit for biogas comprising
a biogas inlet, the biogas containing methane and carbon dioxide; and
a methane outlet;
a separating unit for methane and carbon dioxide connecting to the biogas inlet and the methane outlet; and
a separating unit for carbon dioxide comprising
a heater connecting to the separating unit for methane and carbon dioxide;
a carbon dioxide filter connecting to the heater;
a water tank connecting to the carbon dioxide filter;
a dosing device connecting to the water tank; and
a vacuum pump connecting to the water tank;
wherein the separating unit for methane and carbon dioxide is mounted between the biogas inlet and the methane outlet, and the separating unit for biogas is also mounted between the heater and the water tank.

2. The system as claimed in claim 1, wherein carbon dioxide adsorbents are stored in the dosing device.

3. The system as claimed in claim 2, wherein the carbon dioxide adsorbent is methyldiethanolamine, triethylenetetramine, aminoethylethanolamine, or a combination thereof.

4. The system as claimed in claim 1, wherein a carbon dioxide membrane is mounted in the carbon dioxide filter.

5. The system as claimed in claim 4, wherein one part of the carbon dioxide membrane is in a vacuum condition; the remaining part of the carbon dioxide membrane is filled by a solution containing dissolved and adsorbed carbon dioxide.

6. The system as claimed in claim 1, wherein a water-level controller is mounted on the top of the water tank; a water drainage device is mounted on a sidewall of the water tank.

7. The system as claimed in claim 1, wherein the separating unit for carbon dioxide further comprises a carbon dioxide discharger and a water supply; the carbon dioxide discharger and the water supply connect to the carbon dioxide filter; a degas pump is mounted between the carbon dioxide discharger and the carbon dioxide filter.

8. The system as claimed in claim 1, wherein the separating unit for carbon dioxide further comprises a cooler, and the cooler comprises a hot water pipe and a cold water pipe; the cooler connects to the water tank by the hot water pipe and the cold water pipe.

9. The system as claimed in claim 1, wherein the system further comprises two degas pumps and a hydraulic pump; one of the degas pumps is mounted between the biogas inlet and the separating unit for methane and carbon dioxide, another one of the degas pumps is mounted between the separating unit for methane and carbon dioxide and the methane outlet; the hydraulic pump is mounted between the water tank and the separating unit for methane and carbon dioxide.
